(19) United States
(12) Patent Application Publication
(10) Pub. No.: US 2008/0080741 A1
(43) Pub. Date: Apr. 3, 2008

(54) Occupant detection system

(75) Inventors: Masato Yokoo, Minato-ku (JP); Hiroshi Aoki, Minato-ku (JP); Hirofumi Mita, Minato-ku (JP); Yuu Hakomori, Minato-ku (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/878,403

(22) Filed: Jul. 24, 2007

(30) Foreign Application Priority Data
Sep. 28, 2006 (JP) 2006/265191

(51) Int. Cl. G06K 9/00; B60R 21/16

(52) U.S. Cl. 382/104; 280/735; 340/438

(57) ABSTRACT

The disclosed occupant detection system may include a photographing device, an information extracting device, a detection processing device, an integration processing device, and a determination processing device. The photographing device takes 3D images of a vehicle's driver. The information extracting device extracts information about at least one of a position or movement of the driver's head or hand. The detection processing device detects whether or not the at least one of the position or movement of the driver's head or hand is in a preset specified state. The integration processing device adds up the time in which the at least one of the position or movement of the driver's head or hand is not in the specified state. The determination processing device determines that the driver's attention is diminished when the time added up exceeds a preset reference value.

### BACKGROUND

The present invention relates to an occupant detection system to be installed in a vehicle and, more particularly, a technology for developing an occupant detection system for detecting information about a driver on a vehicle seat.

Conventionally, there are various known techniques for detecting an object occupying a vehicle seat by using a photographing means such as a camera. For example, JP-A-2003-294855 discloses a configuration of an occupant detecting apparatus in which a camera capable of two-dimensionally photographing an object is arranged in front of a vehicle occupant to detect the position of the vehicle occupant by the camera.

In a case where an occupant, such as a driver, is out of the normal position (the standard sitting position) on a vehicle seat, is dozing, or is inattentive, it is estimated that the driver will fail to operate or steer the vehicle due to the diminished attention of the driver. Accordingly, there is a demand to establish a technology of precisely detecting whether or not the attention of the driver is diminished for use in various driving aids. However, it is difficult to precisely detect whether or not the attention of the driver is diminished in the configuration of using a camera two-dimensionally photographing a vehicle occupant, for the following reasons. When there is a small difference in color between the background and the driver or a small difference in color between the skin and the clothes of the driver, a problem arises in that it is difficult to securely detect the driver's head and/or hand(s). In the case of detecting, for example, a head and/or hand(s) of a driver by photographing the driver from the front side of the vehicle, a problem arises in that it is hard to recognize the anteroposterior position of the predetermined region. For example, in the case of detecting the head of the driver, it is hard to recognize the anteroposterior position of the head between the times when the driver leans forward and when the driver sits in the normal state.

The present invention is made in view of the aforementioned points and it is an object of an embodiment of the present invention to provide a technology, relating to an occupant detecting system to be installed in a vehicle, which is effective for precisely detecting whether or not the attention of the driver is diminished.

Though an embodiment of the present invention is typically adapted to an occupant detecting system in an automobile for detecting information about a driver on a vehicle seat, the present invention can be also adapted to an occupant detecting system in a vehicle other than the automobile.

### SUMMARY

An occupant detection system according to an embodiment of the present invention may comprises at least: a photographing device, an information extracting device, a detection processing device, an integration processing device, and a determination processing device.

The photographing device may be a photographing means for taking three-dimensional images of a driver on a vehicle seat within a predetermined moving range. As the photographing device, a 3-D type monocular C-MOS camera, a 3-D type pantoscopic stereo camera, or a laser scanner may be employed. The “predetermined moving range” used here may be typically an area where the head and the upper body of the driver sitting in the vehicle seat may exist or an area where the hands of the driver may exist (for example, a steering wheel, an instrument panel, a shift lever, a parking brake lever, an armrest, and the vehicle seat). There may be one or more photographing devices, if necessary.

The information extracting device may have a function of extracting at least either information about the position of the driver's head, the movement of the driver's head, information about the position of the driver's hand(s) or the movement of the driver's hand(s) based on the three-dimensional images taken by the photographing device. Because the three-dimensional images taken by the photographing device are used, information about the driver's head and/or hand(s) are precisely extracted. The information about the driver's head and/or hand(s) is effective in determining whether or not the driver is out of the normal position on a vehicle seat, is dozing, or is inattentive, that is, the driver's attention is diminished.

The detection processing device has a function of detecting whether or not the position or the movement of at least either the driver's head or the driver's hand(s) is in a preset specified state based on the information extracted by the information extracting device. Specifically, as for the position of the driver's head or the position of the driver's hand(s), it is detected whether or not the position is in a specified location. As for the movement of the driver's head or the movement of the driver's hand(s), it is detected whether or not the movement is a specified movement.

The integration processing device may have a function of, when at least either the driver's head or the driver's hand(s) is out of the specified state based on the detection results of the detection processing device, adding up the time in which the driver's head or hand(s) is not in the specified state. Specifically, as for the position of the driver's head or the position of the driver's hand(s), when the position is out of a specified location, the integration processing device adds up the time in which the position is out of the specified location. As for the movement of the driver's head or the movement of the driver's hand(s), when the movement is out of a specified movement, the integration processing device adds up the time in which the movement is out of the specified movement.

The determination processing device may have a function of, based on the time added up by the integration processing device, determining that the driver's attention is diminished when the time added up exceeds a preset reference value and determines that the driver's attention is not diminished when the time added up is equal to or less than the preset reference value. That is, this determination is made based on the fact that the state in which the time when at least either the driver's head or the driver's hand(s) is out of the specified location or the specified state is relatively long is considered to be the state in which the driver's attention is diminished, that is, a state in which the driver's reaction will easily be delayed for an operation such as steering.

According to the occupant detection system of an embodiment of the present invention, the precise detection of whether or not the driver's attention is diminished is achieved by the respective processes based on the three-dimensional images taken by the photographing device. The result of the determination by the determination processing device about whether or not the driver's attention is diminished may be used for driving assist control in a warning device for informing of a possibility of a vehicle collision, a braking device for applying braking forces to the vehicle, a seat belt device for controlling the winding of a seat belt by a retractor, a device for preventing an occupant from submarining along the seat surface under the seat belt by pushing up the seat cushion in the event of a collision, a device for restraining a driver by an airbag, and a device to be adjusted according to the posture of the driver (for example, a device for adjusting the height of a headrest of the seat).

An occupant detection system of another embodiment of the present invention may further comprise an actuation signal outputting device. The actuation signal outputting device is adapted to output an actuation signal to one or more warning devices for alerting the driver when a vehicle collision is predicted. The actuation signal outputting device is also adapted to vary the output mode of the actuation signal to the one or more warning devices between the times when the determination processing device determines that the driver's attention is diminished and when the determination processing device determines that the driver's attention is not diminished. Specific examples for varying the output mode of the actuation signal which may be employed when it is determined that the driver's attention is diminished may include a mode hastening the output timing of an actuation signal to a certain warning device, a mode increasing the output intensity of an actuation signal to a certain warning device, and a mode changing the output timings of the actuation signals to a plurality of warning devices. The only requirement for the actuation signal outputting device is to output a control signal to the warning device(s). The actuation signal outputting device may have an arrangement such that a control device such as an ECU is arranged between the actuation signal outputting device and the warning device(s) or an arrangement of outputting a control signal directly to the warning device(s).

The arrangement of the occupant detection system according to the aforementioned embodiment of the present invention may be effective for constructing an occupant detection system capable of stirring the driver to concentrate on driving in a case where it is estimated that the driver's attention is diminished, a case where it is estimated that the driver will be delayed in reaction, and a case where it is estimated that the driver may become accustomed to the alarm.

An occupant detection system of still another embodiment of the present invention may further comprise a control signal outputting device. The control signal outputting device may be adapted to output a control signal for controlling the start time of braking to a braking device for applying braking forces to the vehicle according to a pedaling force of the driver. The control signal outputting device may also be adapted to vary the output mode of the control signal to the braking device between the times when the determination processing device determines that the driver's attention is diminished and when the determination processing device determines that the driver's attention is not diminished. Specific examples for varying the output mode of the actuation signal for the purpose of hastening the start time of the braking which may be suitably employed may include a mode in which the clearances between the brake pads and the brake disk or between the brake pads and the brake drum are decreased and a mode in which the operation speed of the brake pads is increased.

The aforementioned arrangement of the occupant detection system according to the embodiment of the present invention is effective for constructing an occupant detection system capable of preventing the driver from being delayed in the braking operation in a case where it is estimated that the driver's attention is diminished and a case where it is estimated that the driver's reaction will be delayed.

A warning system according to an embodiment of the present invention may comprise at least: an occupant detection system as mentioned above, one or more warning devices for alerting the driver, and an actuation signal outputting device. The actuation signal outputting device may be adapted to output an actuation signal to the one or more warning devices when a vehicle collision is predicted. The actuation signal outputting device may be also adapted to vary the output mode of the actuation signal to the one or more warning devices between the times when the determination processing device determines that the driver's attention is diminished and when the determination processing device determines that the driver's attention is not diminished.

The arrangement of the warning system according to the aforementioned embodiment of the present invention may be effective for constructing a warning system capable of stirring the driver to concentrate on driving in a case where it is estimated that the driver's attention is diminished, a case where it is estimated that the driver's reaction will be delayed, and a case where it is estimated that the driver may become accustomed to the alarm.

A braking system according to an embodiment of the present invention may comprise at least an occupant detection system as mentioned above, a braking device for applying braking forces to the vehicle according to a pedaling force of a driver, and a control signal outputting device.

The control signal outputting device may be adapted to output a control signal for controlling the start time of the braking to the braking device. The control signal outputting device is also adapted to vary the output mode of the control signal to the braking device between the times when the determination processing device determines that the driver's attention is diminished and when the determination processing device determines that the driver's attention is not diminished.

The arrangement of the braking system according to the aforementioned embodiment of the present invention may be effective for constructing a braking system capable of preventing the driver from delaying in the braking operation in a case where it is estimated that the driver's attention is diminished and a case where it is estimated that the driver will delay in reacting.

A vehicle according to an embodiment of the present invention may comprise at least an engine/running system, an electrical system, an actuation control device, and an occupant detecting device.

The engine/running system may be a system involving an engine and a running mechanism of the vehicle. The electrical system may be a system involving electrical parts used in the vehicle. The actuation control device may be a device having a function of conducting the actuation control of the engine/running system and the electrical system. The occupant detecting device may be adapted to detect information about a driver on a vehicle seat. The occupant detecting device may comprise an occupant detecting system as mentioned above.

According to this arrangement of the vehicle according the aforementioned embodiment of the present invention, there is provided a vehicle mounted with an occupant detecting system capable of precisely detecting whether or not the driver's attention is diminished by respective processes based on the three-dimensional images taken by the photographing device.

A vehicle according to an embodiment of the present invention may comprise at least an engine/running system, an electrical system, an actuation control device, and at least either the warning system as mentioned above or the braking system as mentioned above.

The engine/running system may be a system involving an engine and a running mechanism of the vehicle. The electrical system may be a system involving electrical parts used in the vehicle. The actuation control device may be a device having the function of conducting the actuation control of the engine/running system and the electrical system.

According to this arrangement of the vehicle according to the aforementioned embodiment of the present invention, there is provided a vehicle mounted with a warning system capable of stirring the driver to concentrate on driving in a case where it is estimated that the driver's attention is diminished, a case where it is estimated that the driver will delay in reacting, and a case where it is estimated that the driver may become accustomed to the alarm and/or a braking system capable of preventing the driver from delaying in the braking operation in a case where it is estimated that the driver's attention is diminished and a case where it is estimated that the driver will delay in reacting.

As described above, the embodiments of the present invention may enable precise detection of whether or not a driver's attention is diminished in an occupant detecting system to be installed in a vehicle.

It is to be understood that both the foregoing general description and the following detailed description are exemplary and explanatory only, and are not restrictive of the invention as claimed.

### BRIEF DESCRIPTION OF THE DRAWINGS

The features, aspects, and advantages of the present invention will become apparent from the following description, appended claims, and the accompanying exemplary embodiments shown in the drawings, which are briefly described below.

FIG. 1 is schematic diagram showing an occupant detection system 100 to be installed in a vehicle according to an embodiment of the present invention.

FIG. 2 is a flow chart showing the “warning control process” for controlling a warning device, such as an operation device 210, according to an embodiment of the present invention.

FIG. 3 is a flow chart showing the “head and hand position-detecting process” of FIG. 2.

FIG. 4 is a flow chart showing the “state-of-head determining process” of FIG. 2.

FIG. 5 is a flow chart showing the “state-of-hand determining process” of FIG. 2.

FIG. 6 is a flow chart showing the “state determining process of the hands gripping the steering wheel” in FIG. 2.

FIG. 7 are side and top views showing an area S1 in which the head of a driver who sits in a vehicle seat 10 in the normal state exists according to an embodiment of the present invention.

FIG. 8 is a plan view showing a lower area S2 of a steering wheel 12.

### DETAILED DESCRIPTION

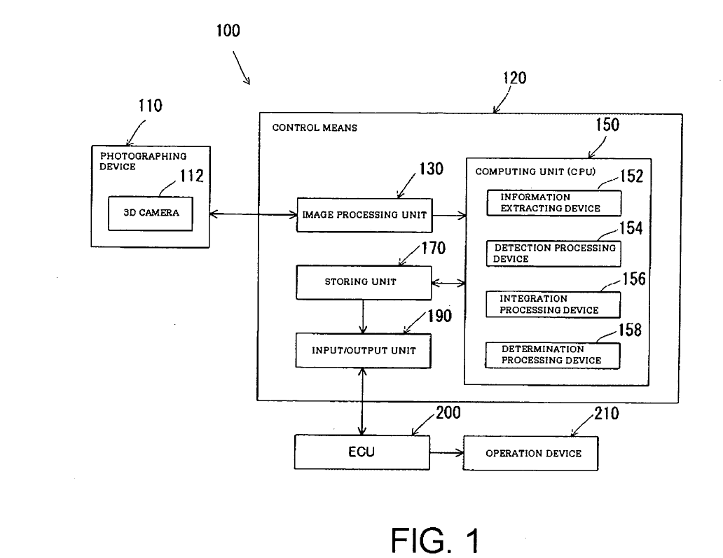

Hereinafter, an embodiment of the present invention will be described with reference to drawings. First, an occupant detecting system or device 100 will be described with reference to FIG. 1.

The configuration of an occupant detection system 100, which is installed in a vehicle, is shown in FIG. 1. The occupant detection system 100 is installed in a vehicle, such as an automobile, for detecting information about a driver and mainly comprises a photographing means or device 110 and a control means 120. Further, the occupant detection system 100 cooperates together with an actuation control device, such as an ECU 200, and an operation device 210 to compose a vehicle aiding system (such as a warning system or a braking system). The vehicle may comprise (not shown) an engine/running system involving an engine and a running mechanism of the vehicle (not shown), an electrical system involving electrical parts used in the vehicle (not shown), and an actuation control device (ECU 200) for conducting the actuation control of the engine/running system and the electrical system.

The photographing means or device 110 may comprise a three-dimensional (3D) camera 112 as the photographing device and a data transfer circuit. The 3D camera 112 is a 3-D camera (sometimes called “monitor”) of a C-MOS or CCD (charge-coupled device) type in which light sensors are arranged into an array (lattice) structure. With this camera, three-dimensional images can be taken from a single view point. Thus, the distance relative to the object is measured a plurality of times to detect a three-dimensional surface profile, thereby identifying the presence or absence, the size, the position, and the posture of the driver. As the 3D camera 112, a 3-D type monocular C-MOS camera or a 3-D type pantoscopic stereo camera may be employed. Instead of the 3D camera 112, a laser scanner capable of obtaining three-dimensional images may be employed.

The camera 112 may be mounted to an area around an inner rearview mirror, an area around a side mirror, a central portion in the lateral direction of the dashboard, or the like of the automobile in such a manner so as to face a predetermined range of movement of the driver. The “predetermined range for movement of the driver” used here may be typically an area where the head and the upper body of the driver sitting in the vehicle seat may exist or an area where the hands of the driver may exist (for example, a steering wheel, an instrument panel, a shift lever, a parking brake lever, an armrest, and the vehicle seat). By using the 3D camera 112, information about the predetermined range for movement of the driver sitting in the vehicle seat is measured periodically at a plurality of times. Mounted on the occupant detection system 100 is a power source unit for supplying power from a vehicle battery to the 3D camera 112. The camera 112 is set to start its photographing operation when the ignition key is turned ON or when a seat sensor (not shown) installed in the driver seat detects an occupant sitting in the driver seat.

The control means 120 may further comprise at least an image processing unit 130, a computing unit (CPU) 150, a storing unit 170, an input/output unit 190, and peripheral devices (not shown). The control means 120 is a means of deriving information about the driver on the vehicle seat based on the images taken by the 3D camera 112.

The image processing unit 130 is a means for controlling the camera to obtain good quality images and for controlling the image processing for processing the images taken by the 3D camera 112 to be used for analysis. Specifically, as to the control of the camera, the adjustment of the frame rate, the shutter speed, and the sensitivity, and the accuracy correction are conducted to control the dynamic range, the brightness, and the white balance. As to the control of the image processing, the spin compensation for the image, the correction for distortion of the lens, the filtering operation, and the differential operation as image preprocessing operations are conducted, and the configuration determination and the tracking as image recognition processing operations are conducted.

The computing unit 150 may comprise at least an information extracting device 152, a detection processing device 154, an integration processing device 156, and a determination processing device 158. In regard to the computing unit 150, some of the information extracting device 152, the detection processing device 154, the integration processing device 156, and the determination processing device 158 may be combined into a single processing device.

The information extracting device 152 may carry out a process of extracting information about the driver based on the information from the image processing unit 130. Specifically, at least either information about the position or movement of the driver's head or information about the position or movement of the driver's hand(s) is extracted (derived) by the information extracting device 152.

The detection processing device 154 may have a function of detecting whether the position or movement of at least either the head or the hand(s) of the driver is in the predetermined specified state based on the information from the information extracting device 152. Specifically, in regard to the position of the head or the position of the hand(s) of the driver, the detection processing device 154 detects whether or not the position is in a specified location. In regard to the movement of the head or the movement of the hand(s), the detection processing device 154 detects whether or not the movement is a specified movement.

The integration processing device 156 may have a function of adding up the time during at least either the head or the hand(s) of the driver is out of the specified state. Specifically, in the case of the position of the head or the position of the hand(s) of the driver, the integration processing device 156 adds up the time during which the position is out of the specified location. In the case of the movement of the head or the movement of the hand(s) of the driver, the integration processing device 156 adds up the time during which the movement is out of the specified movement.

The determination processing device 158 may have a function of determining whether or not the driver's attention is diminished based on the integrated time added up by the integration processing device 156. Specifically, when the integrated time added up by the integration processing device 156 exceeds a preset reference value, it is determined that the driver's attention is diminished. On the other hand, when the integrated time added up by the integration processing device 156 is equal to or less than the reference value, it is determined that the driver's attention is not diminished.

The storing unit 170 may be a buffer frame memory for preprocessing and a means for storing or recording data for correction, for storing defined data for recognition computing, for storing reference patterns, and for storing the computed results of the computing unit 150 as well as operation control software.

The input/output unit 190 may input information about the vehicle, information about traffic conditions around the vehicle, information about the weather condition and about the time zone, and the like to the ECU 200 for conducting the controls of the entire vehicle and output recognition results. In regard to the information about the vehicle, there are, for example, collision prediction information of the vehicle by a radar or camera, the state (open or closed) of a vehicle door, the wearing state of the seat belt, the operation of the brakes, the vehicle speed, and the steering angle. Based on the information outputted from the input/output unit 190, the ECU 200 outputs actuation control signals to the operation device 210.

In regard to the operation device 210, the following may be employed: a warning device for informing of a possibility of a vehicle collision based on the information by radar or camera, a braking device for applying braking forces to the vehicle according to a pedaling force of a driver, a seat belt device for controlling the winding of a seat belt by a retractor, a device (hereinafter, sometimes referred to as the “supporting device”) for preventing an occupant from submarining along the seat surface under the seat belt by pushing up the seat cushion in the event of a collision, a device for restraining a driver by an airbag, and a device to be adjusted according to the posture of the driver (for example, a device for adjusting the height of a headrest of the seat). The only requirement for the input/output unit 190 is to output a control signal to the operation device 210. As shown in FIG. 1, the input/output unit 190 may have an arrangement such that the ECU 200 is arranged between the input/output unit 190 and the operation device 210 or an arrangement of outputting a control signal directly to the operation device 210.

In the case that a warning device for informing of a possibility of a vehicle collision based on the information from a radar or camera is employed as the operation device 210, the input/output unit 190 for outputting an actuation signal to the warning device may correspond to an actuation signal outputting device. In the case that a braking device for applying braking forces to the vehicle according to a pedaling force of a driver is employed as the operation device 210, the input/output unit 190 for outputting a control signal to the braking device may correspond to a control signal outputting device.

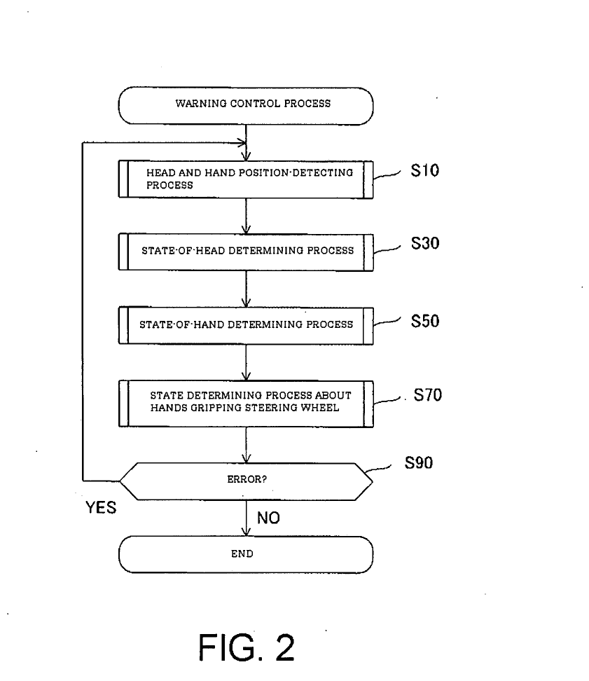

The action of the occupant detection system 100 having the aforementioned structure will be specifically described with reference to FIG. 2 through FIG. 8 in addition to FIG. 1. FIG. 2 through FIG. 6 show the control processes used in the occupant detection system 100. The control processes are carried out by the ECU 200 according to the detection results of the occupant detection system 100 in FIG. 1.

FIG. 2 is a flow chart of the “warning control process” for controlling the warning device as the operation device 210. In the warning control process shown in FIG. 2, a “head and hand position-detecting process” is first conducted at step S10. The information about the positions of the driver's head and hand(s) is derived by this process, but the details will be described later. Then, at step S30, step S50, and step S70, the processes for discriminating the state of the driver's head and hand(s) are conducted. At step S30, the state of the driver's head is determined. At step S50, the state of the driver's hand(s) is determined. Further, at step S70, the state of the driver's hand(s) gripping the steering wheel is determined. At least one of step S30, step S50, and step S70 can be properly omitted, if necessary. After these steps, at step S90, it is determined whether or not the sequence of processes from step S10 to step S70 have been properly carried out. If it is determined that the processes have not been properly carried out, that is, an error occurs (the Yes path in step S90), the procedure is returned to step S10. If it is determined that the processes have been properly carried out (the No path in step S90), the warning control process is terminated. The determination of the error may be carried out at the respective steps from step S10 to step S70, in addition to or instead of at step S90.

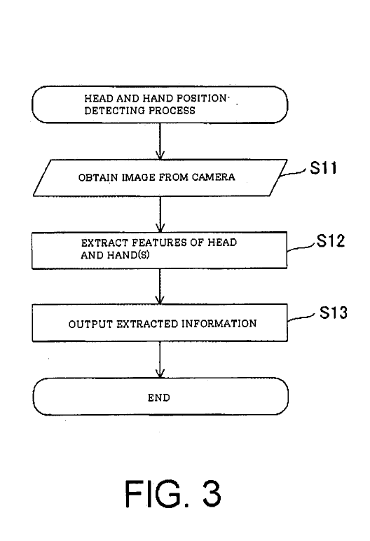

The details of step S10 in FIG. 2 will be described with reference to FIG. 3. FIG. 3 shows a flow chart of the “head and hand position-detecting process” in FIG. 2. In this detecting process, step S11 through step S13 shown in FIG. 3 are sequentially conducted. First, at step S11, a three-dimensional image taken by the 3D camera 112 shown in FIG. 1 is processed by the image processing unit 130. Then, at step S12, features of the driver's head and hand(s) are extracted by the information extracting device 152 in FIG. 1. Then, the extracted information is outputted at step S13. The information outputted at step S13 is stored temporarily in the storing unit 170 in FIG. 1.

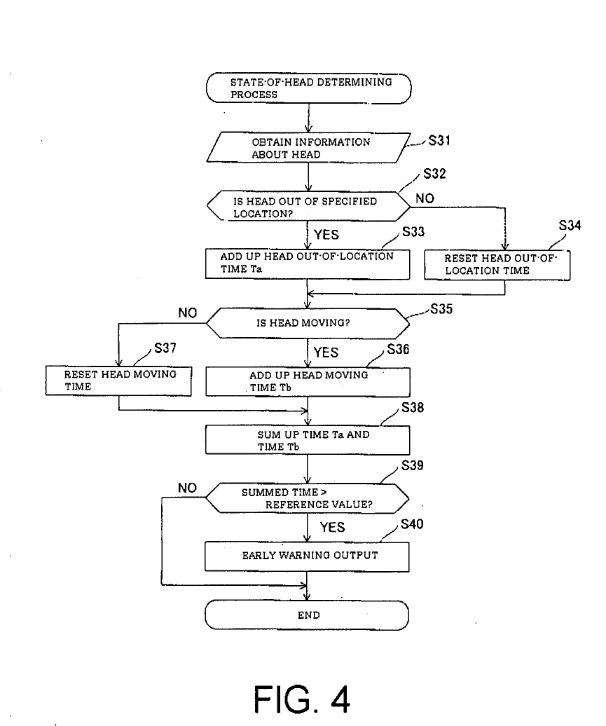

Details of step S30 in FIG. 2 will be described with reference to FIG. 4. FIG. 4 shows a flow chart of the “state-of-head determining process” in FIG. 2. In this determining process, step S31 through step S40 shown in FIG. 4 are sequentially conducted.

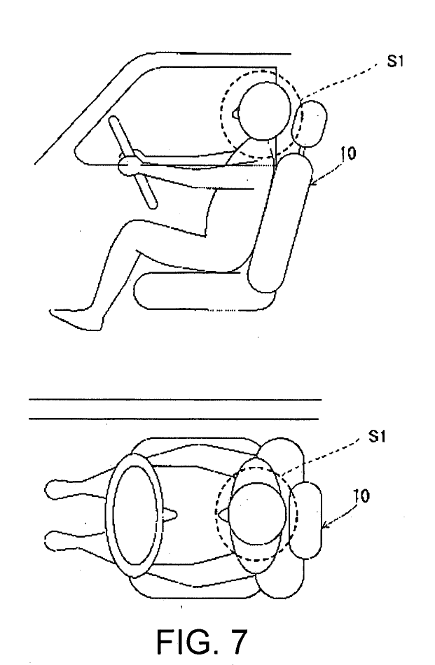

First, at step S31, the features of the driver's head are read out from the storing unit 170. At step S32, the detection processing device 154 shown in FIG. 1 detects whether or not the driver's head is in a specified location, specifically, the range within which the driver's head should exist in the normal driving state that has been previously specified. When the driver's head within the aforementioned range is detected, it is detected that the driver's head is in the specified location. When the driver's head within the aforementioned range is not detected, it is detected that the driver's head is not in the specified location. The specified location used here may be, for example as shown in FIG. 7, any position within an area S1 in which the head of the driver who sits in the vehicle seat 10 in the normal state exists. When the driver's head is not in the specified location, the driver's head may be tilted right or left or forward or backward. If it is detected that the driver's head is not in the specified location (the Yes path in step S32), the procedure proceeds to step S33. If it is detected that the driver's head is in the specified location (the No path in step S32), the procedure proceeds to step S34. At step S33, the integration processing device 156 shown in FIG. 1 adds up the time Ta in which the driver's head is not in the specified location (hereinafter, sometimes referred to as the “head out-of-location time”). On the other hand, at step S34, the integration processing device 156 resets the head out-of-location time.

Then, at step S35, the detection processing device 154 shown in FIG. 1 detects whether or not the driver's head is moving (i.e., the head is in the specified movement state) according to the features of the driver's head read out at step S31. Specifically, the detection processing device 154 detects moment-to-moment changes of the driver's head over time. When the moment-to-moment changes are relatively many, it is detected that the driver's head is moving. When the moment-to-moment changes are relatively few, it is detected that the driver's head is not moving or the movement of the driver's head is small. If it is detected that the driver's head is moving (the Yes path in step S35), the procedure proceeds to step S36. If it is detected that the driver's head is not moving or the movement of the driver's head is small (the No path in step S35), the procedure proceeds to step S37. At step S36, the integration processing device 156 shown in FIG. 1 adds up the time Tb in which the driver's head is moving (hereinafter, sometimes referred to as the “head moving time”). On the other hand, at step S37, the integration processing device 156 resets the head moving time.

Then, at step S38, the integration processing device 156 shown in FIG. 1 sums up the head out-of-location time Ta added up at step S33 and the head moving time Tb added up at step S36. At step S39, the determination processing device 158 shown in FIG. 1 compares the summed time with a preset reference value. If the summed time exceeds the reference value (the Yes path in step S39), an early warning output is conducted at step S40. If not (the No path in step S39), that is, the summed time is equal to or less than the reference value, the determination process is terminated. The early warning output at step S40 is conducted by a control of making the warning device (as the operation device 210) output an alarm under the circumstances that a vehicle collision is predicted and of hastening the timing of outputting an alarm by the warning device as compared to the normal condition in which the driver's head is in the normal state. The output aspect of the alarm by the warning device may be an output by buzz or sound, an output by light or display on the steering wheel or the instrument panel, an output by vibration of the steering wheel or a lever, or a combination of some of these outputs. The “normal state” may be a state in the normal position where the vehicle occupant's back is close to the seat back and the vehicle occupant's head is near to the front surface of the head rest (in standard sitting position). A state departing from the normal position is an out-of-normal position of the vehicle occupant, which is called OOP (out of position).

The state in which the driver's head is out of the specified location and the state in which the driver's head is moving are considered as the state in which the driver's attention is diminished, that is, a state in which the driver's reaction will easily be delayed for operations such as steering. In this case, it is effective to conduct the early warning output at step S40 because the delay in reaction of the driver can be compensated. Instead of the control of hastening the timing for outputting the alarm by the warning device as compared to the normal condition in which the driver's head is in the normal state, a control of increasing the output intensity of an actuation signal to the warning device as compared to the normal condition in which the driver's head is in the normal state may be employed. By employing the control, it is possible to stir the driver to concentrate on driving. This configuration is effective for a case in which the driver may become accustomed to the alarm. When the driver's head is moving, the time required to conduct the processes after step S36 is shortened according to the magnitude of the movement of the head, i.e., the amount of displacement. By shortening the time, it is preferable to hasten the process of detecting whether or not the driver's attention is diminished.

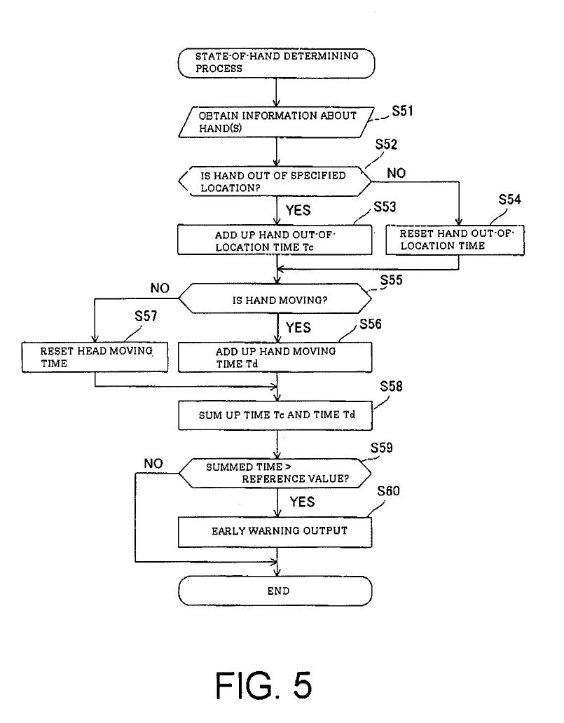

Details of step S50 in FIG. 2 will be described with reference to FIG. 5. FIG. 5 shows a flow chart of the “state-of-hand determining process” in FIG. 2. In this determining process, step S51 through step S60 shown in FIG. 5 are sequentially conducted.

First, at step S51, the features of the driver's hand(s) are read out from the storing unit 170. At step S52, the detection processing device 154 shown in FIG. 1 detects whether or not the driver's hand(s) is in the specified location, specifically, the range within which the driver's hand(s) should exist in the normal driving state that has been previously specified. When the driver's hand(s) within the aforementioned range is detected, it is detected that the driver's hand(s) is in the specified location. When the driver's hand(s) within the aforementioned range is not detected, it is detected that the driver's hand(s) is not in the specified location. When the driver's hand(s) is not in the specified location, the driver's hand(s) may be positioned on a shift lever, a parking brake lever, a seat, an armrest, an instrument panel, or the driver's body. If it is detected that the driver's hand(s) is not in the specified location (the Yes path in step S52), the procedure proceeds to step S53. If it is detected that the driver's hand(s) is in the specified location (the No path in step S52), the procedure proceeds to step S54. At step S53, the integration processing device 156 shown in FIG. 1 adds up the time Tc in which the driver's hand(s) is not in the specified location (hereinafter, sometimes referred to as the “hand out-of-location time”). On the other hand, at step S54, the integration processing device 156 resets the hand out-of-location time.

Then, at step S55, the detection processing device 154 shown in FIG. 1 detects whether or not the driver's hand(s) is moving (the hand(s) is in a specified movement state) according to the features of the driver's hand(s) read out at step S51. Specifically, the detection processing device 154 detects moment-to-moment changes of the driver's hand(s) over time. When the moment-to-moment changes are relatively many, it is detected that the driver's hand(s) is moving. When the moment-to-moment changes are relatively few, it is detected that the driver's hand(s) is not moving or the movement of the driver's hand(s) is small. If it is detected that the driver's hand(s) is moving (the Yes path in step S55), the procedure proceeds to step S56. If it is detected that the driver's hand(s) is not moving or the movement of the driver's hand(s) is small (the No path in step S55), the procedure proceeds to step S57. At step S56, the integration processing device 156 shown in FIG. 1 adds up the time Td in which the driver's hand(s) is moving (hereinafter, sometimes referred to as the “hand moving time”). On the other hand, at step S57, the integration processing device 156 resets the hand moving time.

Then, at step S58, the integration processing device 156 shown in FIG. 1 sums up the hand out-of-location time Tc added up at step S53 and the hand moving time Td added up at step S56. At step S59, the determination processing device 158 shown in FIG. 1 compares the summed time with a preset reference value. If the summed time exceeds the reference value (the Yes path in step S59), an early warning output is conducted at step S60. If not (the No path in step S59), that is, the summed time is equal to or less than the reference value, the determination process is terminated. The early warning output at step S60 is conducted by a control of making the warning device (as the operation device 210) output an alarm under the circumstances a vehicle collision is predicted and of hastening the timing of outputting an alarm by the warning device as compared to the normal condition in which the driver's hand(s) is in the normal state.

The state that the driver's hand(s) is out of the specified location and the state that the driver's hand(s) is moving are considered to be a state in which the driver's attention is diminished, that is, a state in which the driver's reaction will be easily delayed for operations such as steering. In this case, it is effective to conduct the early warning output at step S60 because the delay in reaction of the driver can be compensated. Instead of the control of hastening the timing for outputting the alarm by the warning device as compared to the normal condition in which the driver's hand(s) is in the normal state, a control of increasing the output intensity of an actuation signal to the warning device as compared to the normal condition in which the driver's hand(s) is in the normal state may be employed. By employing the control, it is possible to stir the driver to concentrate on driving. This configuration is effective for a case in which the driver may become accustomed to the alarm. When the driver's hand(s) is moving, the time required to conduct the processes after step S56 is shortened according to the magnitude of movement of the hand(s), i.e., the amount of displacement. By shortening the time, it is preferable to hasten the process of detecting whether or not the driver's attention is diminished.

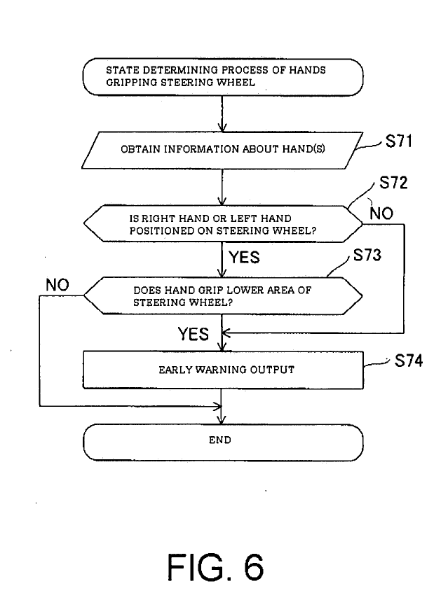

Details of step S70 in FIG. 2 will be described with reference to FIG. 6. FIG. 6 shows a flow chart of the “state determining process of hands gripping the steering wheel” in FIG. 2. In this determining process, step S71 through step S74 shown in FIG. 6 are sequentially conducted.

First, at step S71, the features of the driver's hands are read out from the storing unit 170. At step S72, the detection processing device 154 shown in FIG. 1 detects whether or not at least one of the driver's hands is on the steering wheel, specifically, a predetermined range around the steering wheel that has been previously specified. When the driver's hand(s) within the aforementioned range is detected, it is detected that at least one of the driver's hands is on the steering wheel. When the driver's hand within the aforementioned range is not detected, it is detected that both the driver's hands are not in the specified location. If it is detected that the driver's hand(s) is in the specified location (the Yes path in step S72), the procedure proceeds to step S73. If it is detected that the driver's hands are not in the specified location (the No path in step S72), the procedure proceeds to step S74 to conduct an early warning output.

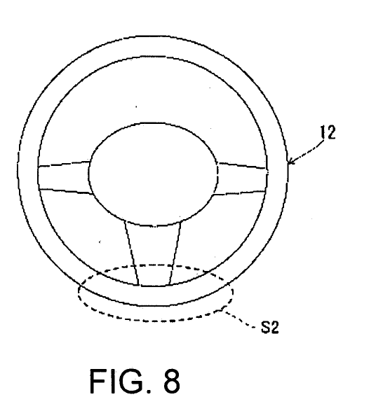

At step S73, the detection processing portion 154 shown in FIG. 1 detects whether or not the driver's hand(s) grips a lower area of the steering wheel. Specifically, a predetermined range in which the hand(s) gripping the lower area of the steering wheel should exist has been previously set. When the driver's hand(s) within the aforementioned range is detected, it is detected that the driver's hand(s) grips the lower area of the steering wheel. When the driver's hand within the aforementioned range is not detected, it is detected that the driver's hands do not grip the lower area of the steering wheel. The range is defined, for example as shown in FIG. 8, as a lower area S2 of the steering wheel 12 to be gripped by the driver's hand(s). In the case of a steering wheel with three spokes, the lower area S2 is an area including a joint between a spoke extending downwardly from a center pad portion of the steering wheel and a wheel portion of the steering wheel and a peripheral area around the joint. In the case of a steering wheel with four spokes, the lower area S2 is an area defined between two spokes extending obliquely downwardly from the center pad portion of the steering wheel and a wheel portion of the steering wheel. If it is detected that the driver's hand(s) grips the lower area of the steering wheel (the Yes path in step S73), the procedure proceeds to step S74 to conduct the early warning output. If it is detected that the driver's hands do not grip the lower area of the steering wheel (the No path in step S73), the process is directly terminated. Similarly to the early warning output at step S40, the early warning output at step S74 is conducted by a control of making the warning device (as the operation device 210) output an alarm under the circumstances a vehicle collision is predicted and of hastening the timing of outputting an alarm by the warning device as compared to the normal condition in which the driver's head is in the normal state.

In this embodiment, the state that the driver's hand(s) grips the lower area of the steering wheel is considered as the state that the driver's reaction will be easily delayed for operations such as steering. In this case, it is effective to conduct the early warning output at step S74 because the delay in reaction of the driver can be compensated. Instead of the control of hastening the timing for outputting the alarm by the warning device as compared to the normal condition in which the driver's hand(s) is in the normal state, a control of increasing the output intensity of an actuation signal to the warning device as compared to the normal condition in which the driver's hand(s) is in the normal state may be employed. By employing the control, it is possible to stir the driver to concentrate on driving. This configuration is effective for a case in which the driver may become accustomed to the alarm.

According to the occupant detection system 100 of the embodiment of the present invention as mentioned above, the detection of whether or not the driver's attention is diminished is achieved by the respective processes based on the three-dimensional images taken by the 3D camera 112. That is, even when there is a small difference in color between the background and the driver or a small difference in color between the skin and the clothes of the driver, or even in the case of detecting the position of the head of the driver who is in a state leaning forward, the arrangement of detecting a three-dimensional image ensures precise detection as compared with the arrangement of detecting a two-dimensional image.

The actuation of the operation device 210 can be controlled in a suitable fashion according to the results of the detection of the occupant detection system 100, thereby enabling detailed control for the operation device 210.

Further, a vehicle is provided with a mounted occupant detection system 100 that is capable of precisely controlling the operation device 210 in a suitable fashion according to the results of the accurate detection of the occupant detection system 100.

The present invention is not limited to the aforementioned embodiments and various applications and modifications may be made. For example, the following embodiments based on the aforementioned embodiments may be carried out.

Though the aforementioned embodiment shown in FIG. 2 through FIG. 6 has been described with regard to a case for using the warning device for informing of a possibility of a vehicle collision based on the information from radar or camera as the operation device 210, a braking device for applying braking forces to the vehicle according to a pedaling force of a driver and a vibration device mounted to a supporting device for preventing an occupant from submarining along the seat surface under the seat belt by pushing up the seat cushion in the event of a collision may be employed as the operation device 210.

In the case of employing a braking device as the operation device 210, the input/output unit 190 is adapted not only to output a control signal for controlling the clearances between the brake pads and the brake disk or between brake pads and a brake drum to the braking device but also to vary the output mode of the control signal to the braking device between the times when the determination processing device 158 determines that the driver's attention is diminished and when the determination processing device 158 determines that the driver's attention is not diminished. Specifically, for the purpose of hastening the start time of the braking, a mode in which the clearances between the brake pads and the brake disk or between the brake pads and the brake drum are set to be smaller than the normal one and a mode in which the operation speed of the brake pads is set to be higher than the normal one may be suitably employed.

In the case of employing a vibration device mounted on the supporting device as the operation device 210, the input/output unit 190 is adapted to vary the output mode of a control signal to the vibration device between the times when the determination processing device 158 determines that the driver's attention is diminished and when the determination processing device 158 determines that the driver's attention is not diminished. Specifically, for the purpose of calling attention, a mode in which the portion to be vibrated by the vibration device is shifted right as compared to the normal case may be employed when the driver leans right because the gravity center of the driver is on the right side.

Though the aforementioned embodiments have been described with regard to a case of employing a single warning device as the operation device 210, a combination of a plurality of devices may be employed as the operation device 210.

For example, a lamp device on an instrument panel, a first vibration device mounted on a supporting device, and a second vibration device mounted on a steering wheel may be combined to compose the operation device 210. In this case, the input/output unit 190 is adapted to vary the output modes of the control signals to the respective three devices (the lamp device, the first vibration device, and the second vibration device) between the times when the determination processing device 158 determines that the driver's attention is diminished and when the determination processing device 158 determines that the driver's attention is not diminished. Specifically, normally when a vehicle collision is predicted, these devices are actuated in the order of the lamp device, the first vibration device, and the second vibration device. On the other hand, when the driver takes one of his hands off the steering wheel to operate switches on the instrument panel so that it seems the driver's attention is diminished, the lamp device and the first vibration device are actuated at the same time before the second vibration device. Accordingly, this arrangement can prevent the driver from being accustomed to the alarm by changing the actuation order of these devices. Because the actuation of the lamp device and the first vibration device has a high effect of calling the driver's attention, the arrangement of actuating the lamp device and the first vibration device before the second vibration device is especially effective in increasing the function of calling the driver's attention. Considering that the vibration by the second vibration device is hardly conducted to the driver during high speed driving, the actuation modes of the three devices may be changed according to the vehicle speed.

Alternatively, a lamp device on an instrument panel and a first vibration device mounted on a supporting device may be combined to compose the operation device 210. In this case, the input/output unit 190 is adapted to vary the output modes of the control signals to the two devices (the lamp device and the first vibration device) between the times when the determination processing device 158 determines that the driver's attention is diminished and when the determination processing device 158 determines that the driver's attention is not diminished. Specifically, normally when a vehicle collision is predicted, these devices are actuated in the order of the lamp device, the first vibration device in a weak vibration mode, and the first vibration device in a strong vibration mode. On the other hand, when the driver takes one of his hands off the steering wheel to operate switches on the instrument panel so that it seems the driver's attention is diminished, the actuation of the lamp device and the strong vibration of the first vibration device are conducted at the same time. Accordingly, this arrangement can prevent the driver from being accustomed to the alarm by changing the actuation order of these devices.

Though the aforementioned embodiments have been described with regard to the arrangement of the occupant detection system 100 to be installed in an automobile, the embodiments of the present invention can be adopted to occupant detection systems to be installed in various vehicles such as an automobile, an airplane, a boat, a bus, and a train.

The priority application Japanese Patent Application No. 2006-265191, filed Sep. 28, 2006, is incorporated by reference herein.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An occupant detection system comprising:
a photographing device for taking three-dimensional images of a driver on a vehicle seat within a predetermined moving range;
an information extracting device for extracting information about at least one of a position of the head of the driver, a movement of the head of the driver, a position of a hand of the driver, and a movement of the hand of the driver based on the three-dimensional images taken by the photographing device;
a detection processing device for detecting whether or not at least one of the position of the driver's head, the position of the driver's hand, the movement of the driver's head, and the movement of the driver's hand is in a preset specified state based on the information extracted by the information extracting device;
an integration processing device for adding up time in which the at least one of the position of the driver's head, the position of the driver's hand, the movement of the driver's head, and the movement of the driver's hand is not in the specified state based on the detection from the detection processing device when the at least one of the position of the driver's head, the position of the driver's hand, the movement of the driver's head, and the movement of the driver's hand is out of the specified state; and
a determination processing device for determining that the driver's attention is diminished when the time added up by the integration processing device exceeds a preset reference value and that the driver's attention is not diminished when the time added up by the integration processing device is equal to or less than the preset reference value.

2. The occupant detection system as claimed in claim 1, further comprising an actuation signal outputting device, wherein the actuation signal outputting device is adapted to output an actuation signal to one or more warning devices for alerting the driver when a vehicle collision is predicted and to vary an output mode of the actuation signal to the one or more warning devices between times when the determination processing device determines that the driver's attention is diminished and when the determination processing device determines that the driver's attention is not diminished.

3. The occupant detection system as claimed in claim 1, further comprising a control signal outputting device, wherein the control signal outputting device is adapted to output a control signal for controlling start time of braking to a braking device for applying braking forces to vehicle according to a pedaling force of the driver and to vary an output mode of the control signal to the braking device between times when the determination processing device determines that the driver's attention is diminished and when the determination processing device determines that the driver's attention is not diminished.

4. The occupant detection system as claimed in claim 1, wherein the information extracting device extracts information about at least two of the position of the head of the driver, the movement of the head of the driver, the position of the hand of the driver, and the movement of the hand of the driver;
wherein the detection processing device detects whether or not the at least two of the position of the driver's head, the position of the driver's hand, the movement of the driver's head, and the movement of the driver's hand are in their respective preset specified states.

5. The occupant detection system as claimed in claim 4, wherein the integration processing device adds up time in which the at least two of the position of the driver's head, the position of the driver's hand, the movement of the driver's head, and the movement of the driver's hand are not in their respective specified states when the at least two of the position of the driver's head, the position of the driver's hand, the movement of the driver's head, and the movement of the driver's hand are out of their respective specified states.

6. The occupant detection system as claimed in claim 1, wherein the information extracting device extracts information about at least one of the positions of both hands of the driver and the movements of both hands of the driver;
wherein the detection processing device detects whether or not the at least one of the positions of both hands of the driver or the movements of both hands of the driver are in a preset specified state;
wherein the integration processing device adds up time in which the at least one of the positions of both hands of the driver or the movements of both hands of the driver are not in the specified state when the at least one of the positions of both hands of the driver or the movements of both hands of the driver are out of the specified state.

7. A warning system comprising:
an occupant detection system comprising:
a photographing device for taking three-dimensional images of a driver on a vehicle seat within a predetermined moving range,
an information extracting device for extracting information about at least one of a position of the head of the driver, a movement of the head of the driver, a position of a hand of the driver, and a movement of the hand of the driver based on the three-dimensional images taken by the photographing device,
a detection processing device for detecting whether or not at least one of the position of the driver's head, the position of the driver's hand, the movement of the driver's head, and the movement of the driver's hand is in a preset specified state based on the information extracted by the information extracting device,
an integration processing device for adding up time in which the at least one of the position of the driver's head, the position of the driver's hand, the movement of the driver's head, and the movement of the driver's hand is not in the specified state based on the detection from the detection processing device when the at least one of the position of the driver's head, the position of the driver's hand, the movement of the driver's head, and the movement of the driver's hand is out of the specified state, and
a determination processing device for determining that the driver's attention is diminished when the time added up by the integration processing device exceeds a preset reference value and that the driver's attention is not diminished when the time added up by the integration processing device is equal to or less than the preset reference value;
one or more warning devices for alerting the driver; and
an actuation signal outputting device which is adapted to output an actuation signal to the one or more warning devices when a vehicle collision is predicted and to vary an output mode of the actuation signal to the one or more warning devices between times when the determination processing device determines that the driver's attention is diminished and when the determination processing device determines that the driver's attention is not diminished.

8. A braking system for a vehicle comprising:
an occupant detection system comprising:
a photographing device for taking three-dimensional images of a driver on a vehicle seat within a predetermined moving range,
an information extracting device for extracting information about at least one of a position of the head of the driver, a movement of the head of the driver, a position of a hand of the driver, and a movement of the hand of the driver based on the three-dimensional images taken by the photographing device,
a detection processing device for detecting whether or not at least one of the position of the driver's head, the position of the driver's hand, the movement of the driver's head, and the movement of the driver's hand is in a preset specified state based on the information extracted by the information extracting device,
an integration processing device for adding up time in which the at least one of the position of the driver's head, the position of the driver's hand, the movement of the driver's head, and the movement of the driver's hand is not in the specified state based on the detection from the detection processing device when the at least one of the position of the driver's head, the position of the driver's hand, the movement of the driver's head, and the movement of the driver's hand is out of the specified state, and
a determination processing device for determining that the driver's attention is diminished when the time added up by the integration processing device exceeds a preset reference value and that the driver's attention is not diminished when the time added up by the integration processing device is equal to or less than the preset reference value;
a braking device for applying braking forces to the vehicle according to a pedaling force of a driver; and
a control signal outputting device which is adapted to output a control signal for controlling start time of braking to the braking device and to vary an output mode of the control signal to the braking device between times when the determination processing device determines that the driver's attention is diminished and when the determination processing device determines that the driver's attention is not diminished.

9. A vehicle comprising:
an engine/running system;
an electrical system;
an actuation control device for conducting actuation control of the engine/running system and the electrical system; and
an occupant detecting device for detecting information about a driver on a vehicle seat, wherein the occupant detecting device comprises:
a photographing device for taking three-dimensional images of a driver on a vehicle seat within a predetermined moving range,
an information extracting device for extracting information about at least one of a position of the head of the driver, a movement of the head of the driver, a position of a hand of the driver, and a movement of the hand of the driver based on the three-dimensional images taken by the photographing device,
a detection processing device for detecting whether or not at least one of the position of the driver's head, the position of the driver's hand, the movement of the driver's head, and the movement of the driver's hand is in a preset specified state based on the information extracted by the information extracting device,
an integration processing device for adding up time in which the at least one of the position of the driver's head, the position of the driver's hand, the movement of the driver's head, and the movement of the driver's hand is not in the specified state based on the detection from the detection processing device when the at least one of the position of the driver's head, the position of the driver's hand, the movement of the driver's head, and the movement of the driver's hand is out of the specified state, and
a determination processing device for determining that the driver's attention is diminished when the time added up by the integration processing device exceeds a preset reference value and that the driver's attention is not diminished when the time added up by the integration processing device is equal to or less than the preset reference value.

10. A vehicle comprising:
an engine/running system;
an electrical system;
an actuation control device for conducting actuation control of the engine/running system and the electrical system; and
a warning system comprising:
an occupant detection system, wherein the occupant detection system comprises:
a photographing device for taking three-dimensional images of a driver on a vehicle seat within a predetermined moving range,
an information extracting device for extracting information about at least one of a position of the head of the driver, a movement of the head of the driver, a position of a hand of the driver, and a movement of the hand of the driver based on the three-dimensional images taken by the photographing device,
a detection processing device for detecting whether or not at least one of the position of the driver's head, the position of the driver's hand, the movement of the driver's head, and the movement of the driver's hand is in a preset specified state based on the information extracted by the information extracting device,
an integration processing device for adding up time in which the at least one of the position of the driver's head, the position of the driver's hand, the movement of the driver's head, and the movement of the driver's hand is not in the specified state based on the detection from the detection processing device when the at least one of the position of the driver's head, the position of the driver's hand, the movement of the driver's head, and the movement of the driver's hand is out of the specified state, and
a determination processing device for determining that the driver's attention is diminished when the time added up by the integration processing device exceeds a preset reference value and that the driver's attention is not diminished when the time added up by the integration processing device is equal to or less than the preset reference value;
one or more warning devices for alerting the driver; and
an actuation signal outputting device which is adapted to output an actuation signal to the one or more warning devices when a vehicle collision is predicted and to vary an output mode of the actuation signal to the one or more warning devices between times when the determination processing device determines that the driver's attention is diminished and when the determination processing device determines that the driver's attention is not diminished.

11. A vehicle comprising:
an engine/running system;
an electrical system;
an actuation control device for conducting actuation control of the engine/running system and the electrical system; and
a braking system comprising:
an occupant detection system, wherein the occupant detection system comprises:
a photographing device for taking three-dimensional images of a driver on a vehicle seat within a predetermined moving range,
an information extracting device for extracting information about at least one of a position of the head of the driver, a movement of the head of the driver, a position of a hand of the driver, and a movement of the hand of the driver based on the three-dimensional images taken by the photographing device,
a detection processing device for detecting whether or not at least one of the position of the driver's head, the position of the driver's hand, the movement of the driver's head, and the movement of the driver's hand is in a preset specified state based on the information extracted by the information extracting device,
an integration processing device for adding up time in which the at least one of the position of the driver's head, the position of the driver's hand, the movement of the driver's head, and the movement of the driver's hand is not in the specified state based on the detection from the detection processing device when the at least one of the position of the driver's head, the position of the driver's hand, the movement of the driver's head, and the movement of the driver's hand is out of the specified state, and
a determination processing device for determining that the driver's attention is diminished when the time added up by the integration processing device exceeds a preset reference value and that the driver's attention is not diminished when the time added up by the integration processing device is equal to or less than the preset reference value;
a braking device for applying braking forces to the vehicle according to a pedaling force of a driver; and
a control signal outputting device which is adapted to output a control signal for controlling start time of braking to the braking device and to vary an output mode of the control signal to the braking device between times when the determination processing device determines that the driver's attention is diminished and when the determination processing device determines that the driver's attention is not diminished.
